(19) United States
(12) Patent Application Publication
(10) Pub. No.: US 2012/0237897 A1
(43) Pub. Date: Sep. 20, 2012

(54) Dental Appliance For Abrading Dental Resin

(76) Inventor: Jeffrey T. Allen, Bloomington, IN (US)

(21) Appl. No.: 13/487,385

(22) Filed: Jun. 4, 2012

Related U.S. Application Data
(63) Continuation-in-part of application No. 13/093,487, filed on Apr. 25, 2011.
Application No. 13/093,487 is a continuation-in-part of application No. 12/467,592, filed on May 18, 2009, now abandoned.
Application No. 12/467,592 is a continuation-in-part of application No. 11/891,820, filed on Aug. 13, 2007, now abandoned.
(60) Provisional application No. 60/837,482, filed on Aug. 14, 2006.

(51) Int. Cl. A61C 15/04

(52) U.S. Cl. 433/142

(57) ABSTRACT

A dental appliance for abrading dental resin, particularly in the interproximal space, is characterized by a length of dental tape formed of a supple, synthetic monofilament material of a rectangular cross section having an abrading material on an exterior portion thereof suitable for abrading dental resin, and a plastic threading element attached to an end of the dental tape for allowing the insertion of the dental tape into the interproximal space via the side. In one form, the dental abrading appliance has an abrading section formed of a continuous abrader or having an alternating pattern of non-abrading and abrading portions along a length of the dental tape. The abrading portions may be a single grit of the dental abrading material or may be different grits of the dental abrading material. In another form, the dental abrading tape has a single grit of a dental abrading material about its entire length.

### CROSS-REFERENCE TO RELATED APPLICATIONS

This patent application is a continuation-in-part of co-pending U.S. patent application serial number 13/093,487 filed Apr. 25, 2011 entitled “Dental Element For Abrading Dental Composite Resin”, which is a continuation-in-part of U.S. patent application Ser. No. 12/467,592 filed May 18, 2009 entitled “Dental Finishing, Sanding and/or Polishing Floss”, now abandoned, which is a continuation-in-part of now abandoned U.S. patent application Ser. No. 11/891,820 filed Aug. 13, 2007, entitled “Dental Finishing, Sanding and/or Polishing Floss”, now abandoned, which claims the benefit of and/or priority to U.S. provisional patent Application Ser. No. 60/837,482 filed Aug. 14, 2006, entitled “Dental Finishing and Polishing Floss”, the entire contents of all of which are specifically incorporated herein by reference.

### BACKGROUND OF THE INVENTION

1. Field of the Invention

The present invention relates to dental appliances used for interproximal finishing, polishing and/or sanding of a dental restorative material.

2. Background Information

Resins rather than amalgams are now predominately used for filling cavities or other dental decay and/or as a general dental restorative material. These resins possess properties that closely match natural teeth with respect to structural properties such as cohesive strength, coefficient of thermal expansion and wearability. Also, aesthetic considerations such as color stability, refractive index, plaque repellency, polishability and opacity are important factors make resins a good choice as a dental restorative material.

These composite resins have good forming characteristics so that they can be shaped to fit a cavity area or molded into place in order to repair chipped or damaged teeth. However, it is necessary to shape the repaired area by polishing or sanding the resin once the resin is cured. For instance, when resin is placed in the interproximal surface of posterior teeth such as for fixing a cavity, a matrix band is used so that the resin does not bond to the adjacent tooth. As a result, resin can overflow past the margin of the floor of the cavity preparation causing an overhang of composite resin that can create periodontal disease due to inflamed gingival or recurrent decay. Because it is optimal to create a tight, dense contact between the composite resin and the tooth in order to prevent a food trap.

One of the ways to remove a composite resin overhang is to use a scalpel such as a size 11 scalpel. This is not always effective and can traumatize the gum tissue. Another way to remove a composite resin overhang and composite resin in general is to sand it with an abrasive. Abrasive removal is currently accomplished using a plastic dental strip (i.e. a rectangular plastic sheet) that has a polishing material thereon. These sheet plastic strips however, are not ideal. If one uses a sheet plastic dental strip for polishing, the strip will crease and therefore be unable to fit through the tight contact around the resin overhang, thereby rendering the strip useless. Another manner of accomplishing abrading is by using a metal strip that has a polishing material thereon. However, if one uses a metal strip for polishing, the metal does not contour to the curvature of the tooth and thus strips the contact thereby creating a food trap (e.g. food getting caught between the teeth). Moreover, with metal polishing strips, the gum tissue is more likely to be cut or shred.

The above illustrates the problems with and shortcomings of using sheet plastic dental strips for abrading dental composite resin particularly in the interproximal space, and more particularly to resin overhang in the interproximal space. In view of this, U.S. Patent Publication 2002/0081550 A1 of Karazivan discloses a tooth coating applicator in the form of a woven fibrous strip. Fibrous materials, however, such as the Karazivan strip, suffers from the same disadvantages and shortcomings of sheet plastic dental strips used for abrading dental composite resin, particularly in overhang situations. Moreover, fibrous materials split and/or come apart. The same limitations are true of U.S. Patent Publication 2005/0058963 A1 of Stockstill who discloses an interproximal reduction stripper in the form of a strip. The Stockstill strip has two distinct ends with a first end having a single abrasive side and a second end with abrasive on both sides.

While, as noted above, there are various dental polishing devices, they are deficient in their ability to be easily introduced into the interproximal area between two teeth and to abrade dental resin.

It is therefore an object of the present invention to overcome the prior art deficiencies noted above, and to provide a dental appliance that allows easy introduction into the interproximal area between two teeth and abrade dental resin, particularly, but not necessarily, with respect to an interproximal dental resin overhang as a result of a dental procedure.

### SUMMARY OF THE INVENTION

The present invention is a dental appliance for abrading dental composite resin, particularly in the interproximal area between two teeth. The dental appliance is formed by a length of supple, synthetic monofilament dental tape having a rectangular cross section, an abrading material on one or more sides of the dental tape, and a plastic threading element attached to one end of the dental tape, the plastic threading element configured to allow introduction into the interproximal area from the side thereof.

The dental tape is formed of a ribbon of a supple synthetic material such as polytetrafluroethylene (PTFE or Teflon®), Gore-Tex®, nylon, rayon, silk, or the like. The abrading material is held onto the dental tape by glue and has a grit whose texture, composition and/or characteristics are sufficient to abrade dental resin.

The abrading material may be situated on one side or both. Moreover, the grit texture, composition and/or characteristics of the abrading material may be the same on one side, both sides, or may change along the length of the dental tape. Such change may be gradual and/or provided as sections or portions along the length. In one form, the dental tape has a single grit of the abrading material along and about its entire length.

The plastic threading element may be configured as a needle of a size that can be easily introduced into the interproximal area. As such, the present dental abrading appliance may be made with needles of different sizes in order to accommodate variations in dental anatomy.

The present invention will be more apparent upon reading the following detailed description in conjunction with the accompanying drawings.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 depicts an embodiment of a dental appliance for abrading dental resin fashioned in accordance with the present principles;

FIG. 2 depicts another embodiment of a dental appliance for abrading dental resin fashioned in accordance with the present principles;

FIG. 3 depicts a further embodiment of a dental appliance for abrading dental resin fashioned accordance with the present principles;

FIG. 4 is a sectional view of the dental appliance of FIG. 3 taken along line 4-4 of FIG. 3;

FIG. 5 is a representation of a length of the present dental abrading appliance on a dental tray;

FIG. 6 is a view of a jaw of a dental patient with an area of the jaw in cutaway showing an interproximal area where a dental procedure has taken place and dental overhang has occurred;

FIG. 6A is an enlargement of the circled area of FIG. 6 particularly showing the interproximal area thereof illustrating a dental resin filling and overhang extending about a tooth before abrasion of the dental resin with the present dental abrading appliance shown ready to abrade the dental resin from the top of the interproximal area and through the side of the interproximal area;

FIG. 7 depicts a further embodiment of a dental appliance for abrading dental resin fashioned in accordance with the present principles;

FIG. 8 depicts a further embodiment of a dental appliance for abrading dental resin fashioned in accordance with the present principles; and

FIG. 9 depicts a further embodiment of a dental appliance for abrading dental resin fashioned in accordance with the present principles.

Like reference numerals indicate the same or similar parts throughout the several figures.

A detailed description of the features, functions and/or configuration of the components depicted in the various figures will now be presented. It should be appreciated that not all of the features of the components of the figures are necessarily described. Some of these non discussed features as well as discussed features are inherent from the figures. Other non discussed features may be inherent in component geometry and/or configuration.

### DETAILED DESCRIPTION OF THE PREFERRED EMBODIMENTS

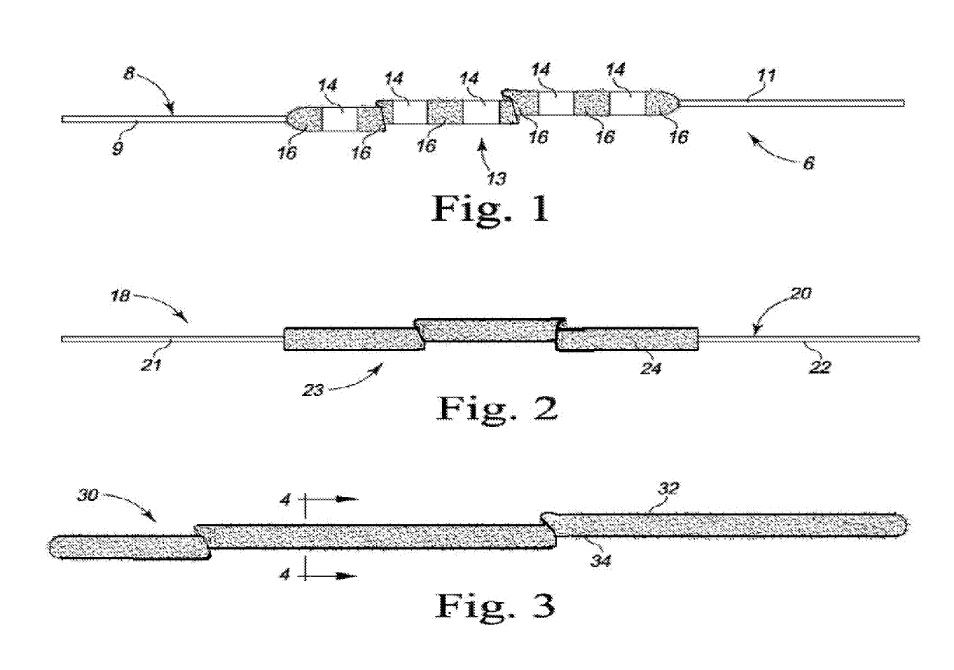

Referring to FIG. 1 there is depicted an exemplary embodiment of a dental appliance, generally designated 6, for abrading dental resin. The dental abrading appliance 6 is defined by a length of dental tape 8 that is made from a supple, synthetic monofilament fiber such as, but not limited to, nylon, rayon, PTFE, Gore-Tex® or the like. As such, the length of dental tape 8 may be a continuous length of tape or an individual piece thereof of any length.

The length of dental tape 8 has a rectangular cross section throughout its entire length and an abrading section 13 situated between a first lateral length 9 of dental tape and a second lateral length 11 of dental tape each of which do not have any abrasive material thereon. The abrading section 13 has an alternating pattern of non-abrading portions 14 and abrading portions 16 along the length thereof.

In this embodiment, the abrading section 13 is formed of an alternating pattern of non-abrading portions 14 and abrading portions 16 along the length of the abrading section 13. The abrading sections have an abrading material or abrader provided about/around the entire circumference and length of each abrading section. The abrading material can be impregnated into, coated onto via glue, or otherwise formed into/onto the surface of the dental tape. The abrading material is of a gritty substance such as is known in the art for abrading a dental restorative material (i.e. a dental resin).

The abrading portions 16, in one form, are each of the same grit or texture. Different dental abrading flosses 6 (or abrading sections 13 thereof) may have grit portions 16 of different grits or textures. For instance, one dental abrading floss 6 may have “coarse” grit abrasive/abrading portions 16 for coarse abrading, one dental abrading floss 6 may have “medium” grit abrading portions 16 for medium abrading, and one dental abrading floss 6 may have “fine” grit abrading portions 16 for fine abrading. In all cases, the grit has the suitable characteristics, features and textures to abrade dental resin.

Alternatively, in another form of the present invention, the abrading portions 16 are of different grits or textures along the length of the abrasion portion 13. Preferably, however, the same dental abrading tape 6 does not have a wide variant of grits or textures along its length (e.g. “fine” to “coarse” abrading portions 16), but may if desired. Typically, however, the abrading portion 13 has a range of abrading portions 16 within a same or similar grit or texture range such as a range of “fine” grits, a range of “medium” grits, or a range of “coarse” grits. For instance, a first abrading portion 16 (as arbitrarily viewed starting from the left side of FIG. 1) may have a “super, super fine” grit, then a “super fine” grit, and so forth within a range of “fine” grits.

Referring now to FIG. 2 there is depicted another embodiment of the present dental abrading appliance fashioned in accordance with the principles of the present invention. Particularly, there is depicted a dental abrading appliance 18 defined by a piece of dental tape 20. The dental abrading appliance 18 is again defined by a length of dental tape 20 that is made from a supple, synthetic monofilament fiber such as, but not limited to, nylon, rayon, PTFE, Gore-Tex® or the like. As such, the length of dental tape 20 may be a continuous length of tape or an individual piece thereof of any length.

In accordance with the principles of the present invention, the length of tape 20 has an abrading section 23 connected between non-abrading portions 21 and 22 thereof. The abrading section 23 has a dental abrading material 24 impregnated into, glued to, or coated onto the abrading section 23. The dental abrading material 24 is a gritty or textured material such as is known in the art for abrading a dental restorative material (e.g. a dental resin). The dental abrading material 24 is of a single grit or texture such as “fine”, “medium”, “coarse” or the like.

FIG. 2 also represents an embodiment of an abrading dental tape such as is described in connection with FIG. 1 wherein the abrading section 23 is a plastic strip. The abrading section 23 is of a gritty or textured material such as is known in the art for finishing, polishing and/or sanding (abrading) a dental restorative material (e.g. a dental resin). The dental abrading material 24 is of a single grit or texture such as “fine”, “medium”, “coarse” or the like. In this embodiment, it should be appreciated, that the abrading section 23 is shown in FIG. 2 as an enlarged portion—this is for clarity to understand the nature of the abrading section 23 of the dental tape, but is not necessarily so.

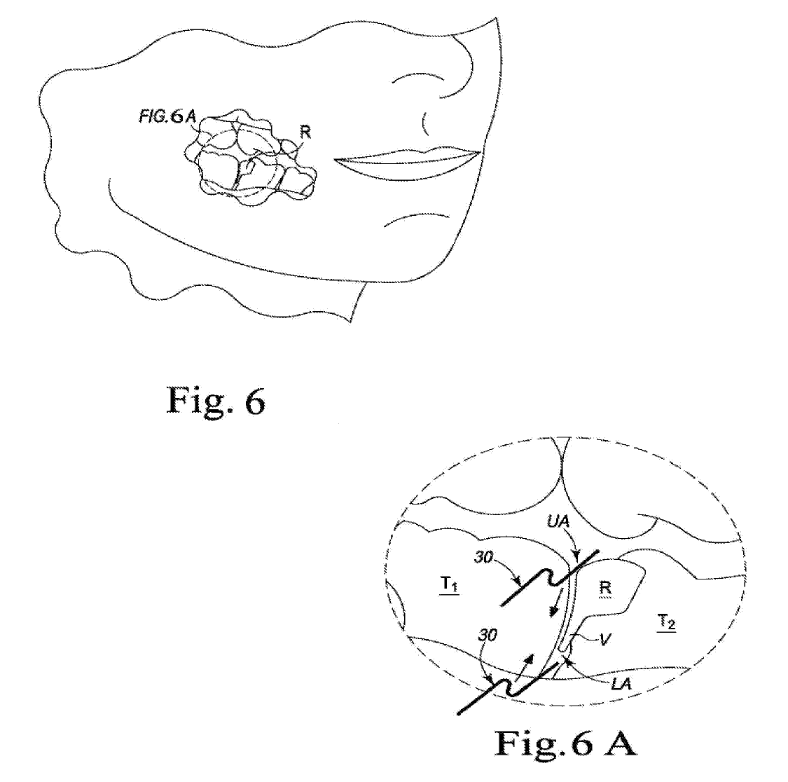

Referring to FIG. 3 there is depicted another embodiment of the present dental abrading tape fashioned in accordance with the principles of the present invention. Particularly, there is depicted a piece or length of dental abrading tape, generally designated 30. The dental abrading tape 30 is defined by a length of dental tape 8 that is made from a supple, synthetic monofilament fiber such as, but not limited to, nylon, rayon, PTFE, Gore-Tex® or the like. As such, the length of dental tape 8 may be a continuous length of tape (such as depicted in FIG. 6 wherein a long length of the present dental abrading tape 30 is shown piled on a tray) or an individual piece thereof of any length.

In this embodiment, the length of tape 32 is entirely impregnated, coated, glued, or otherwise provided with a dental abrader or abrading material (abrader) 34 thereon and around the circumference of the entire length of tape 32. The abrader 34 is a gritty textured material such as is known in the art for abrading a dental restorative material (i.e. a dental composite resin). The dental abrading material 34 is preferably, but not necessarily of a single grit such as fine, medium, coarse or therebetween. The length of tape 32 may also have a change in grit along its length such as described above. In all cases, the length of tape 32 has the characteristics of dental tape wherein it is strong, resilient and flexible in order to allow the dental abrading tape to get into the areas between teeth (interproximal) and to places around a tooth wherein it is traditionally difficult to do with sheet-plastic strips, threaded floss, or the like.

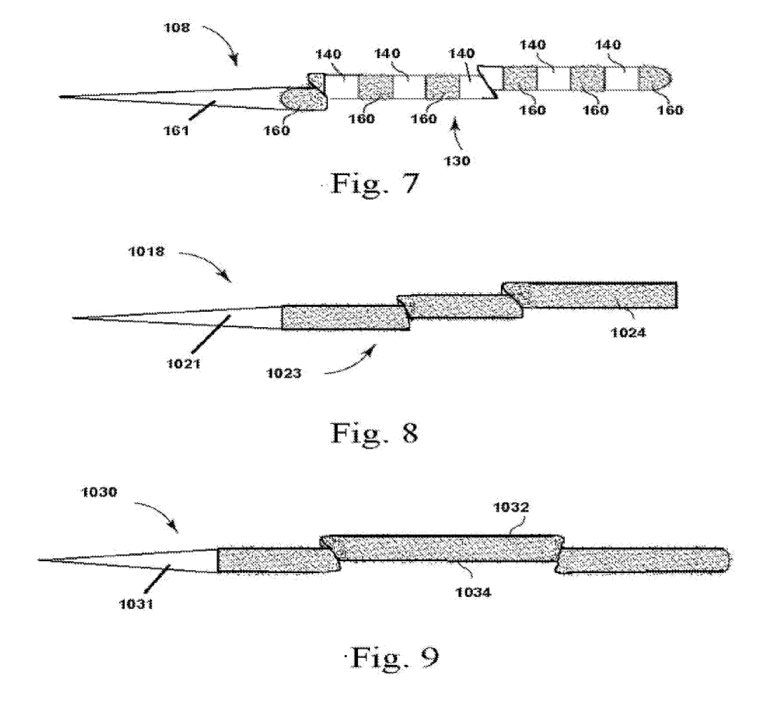

In FIG. 7 there is depicted a partial view of a lower portion of a person's face particularly showing the jaw thereof. A segment of the person's jaw is shown in cutaway view wherein several teeth are visible and a patch, implant or filling of a dental composite resin (restorative material) R is seen particularly with respect to the interproximal area thereof. As better seen in FIG. 7A, the filling of dental composite resin R is seen in greater detail with respect to its host tooth T₂ and an adjacent tooth T₁ of which an overhang V that extends downward from the main body of the filling R into the interproximal area can be seen. It is thus necessary to remove the overhang V. The overhang V is not easily reached since it is in the interproximal space between tooth T₁ and tooth T₂. It can be discerned that a sheet-plastic strip or threaded floss would not be easily inserted into the aforementioned interproximal space. With the present dental abrading tape 30 (or any embodiment described and/or shown herein), the interproximal area or space can be reached such that abrading of the overhang V can be accomplished.

As illustrated in FIG. 7A the dental abrading appliance 30 may be inserted into the interproximal space/area between tooth T₁ and tooth T₂ from above the teeth via an upper area UA or from the side of the teeth via a lower area LA. When coming from above, the tape is slid through and between the teeth T₁, T₂ to reach the overhang V. Since the tape 30 has the characteristics described herein, this can be easily accomplished. When the dental abrading appliance 30 comes from the side, it must be inserted or threaded through/into the teeth T₁, T₂, typically near the gum line. Since the present abrading tape 30 has the characteristics described herein, this can be easily accomplished.

Referring now to FIG. 7, there is depicted another embodiment of a dental appliance for abrading dental resin, particularly, but not necessarily, within an interproximal space, generally designated 108. The dental abrading appliance 108 is defined by a length of dental tape 130 that is made from a supple, synthetic monofilament fiber such as, but not limited to, nylon, rayon, PTFE, Gore-Tex® or the like, with a plastic (or similar) threading element 161 connected to one end of the tape 130. The length of dental tape 130 is may be a continuous length of tape or an individual piece thereof of any length.

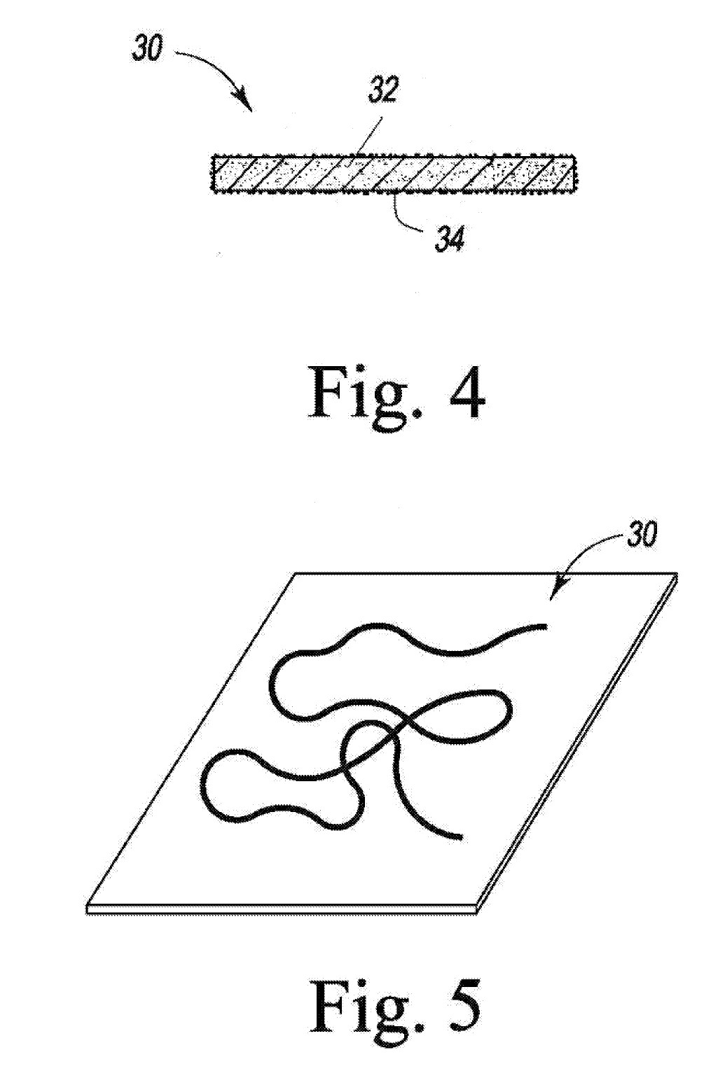

The length of dental tape 130 has a rectangular cross section throughout its entire length (such as in FIG. 4) and has an alternating pattern of non-abrading portions 140 and abrading portions 160 on at least one side of the tape 130. he abrading material can be impregnated into, coated onto via glue, or otherwise formed into/onto the surface of the dental tape. The abrading material is of a gritty substance such as is known in the art for abrading a dental restorative material (i.e. a dental resin). The pattern may be as that described with reference to the embodiment of FIG. 1.

The threading element 161 is formed as a needle, cone, spear, or the like of plastic, but may be formed of other like materials. As such, the threading element 161 may be flat, round or otherwise, as long as the shape thereof is suitable for introduction into an interproximal space/area. The threading element 161 is connected to the dental tape 130 by glue, heat treatment, or other manufacturing process. The threading element 161 thus easily allows the user to get the abrading dental tape portion 130 into the interproximal space from the side thereof. Once introduced, the user can abrade the dental resin by a back and forth motion.

Referring now to FIG. 8, there is depicted another embodiment of a dental appliance for abrading dental resin, particularly, but not necessarily, within an interproximal space, generally designated 1018. The dental abrading appliance 1018 is defined by a length of dental tape 1023 that is made from a supple, synthetic monofilament fiber such as, but not limited to, nylon, rayon, PTFE, Gore-Tex® or the like, with a plastic (or similar) threading element 1021 connected to one end of the tape 1023. The length of dental tape 1023 is may be a continuous length of tape or an individual piece thereof of any length.

The length of dental tape 1023 has a rectangular cross section throughout its entire length (such as in FIG. 4) and has abrading material 1024 continuous along only one side of the tape 1023. The abrading material 1024 can be impregnated into, coated onto via glue, or otherwise formed into/onto the surface of the dental tape. The abrading material 1024 is of a gritty substance such as is known in the art for abrading a dental restorative material (i.e. a dental resin).

The threading element 1021 is formed as a needle, cone, spear, or the like of plastic, but may be formed of other like materials. As such, the threading element 1021 may be flat, round or otherwise, as long as the shape thereof is suitable for introduction into an interproximal space/area. The threading element 1021 is connected to the dental tape 1023 by glue, heat treatment, or other manufacturing process. The threading element 1021 thus easily allows the user to get the abrading dental tape portion 1023 into the interproximal space from the side thereof. Once introduced, the user can abrade the dental resin by a back and forth motion.

Referring now to FIG. 9, there is depicted another embodiment of a dental appliance for abrading dental resin, particularly, but not necessarily, within an interproximal space, generally designated 1030. The dental abrading appliance 1030 is defined by a length of dental tape 1034 that is made from a supple, synthetic monofilament fiber such as, but not limited to, nylon, rayon, PTFE, Gore-Tex® or the like, with a plastic (or similar) threading element 1031 connected to one end of the tape 1034. The length of dental tape 1034 is may be a continuous length of tape or an individual piece thereof of any length.

The length of dental tape 1034 has a rectangular cross section throughout its entire length (such as in FIG. 4) and has abrading material 1034 continuous along both sides of the tape 1034 of which only one side can be seen. The abrading material 1034 can be impregnated into, coated onto via glue, or otherwise formed into/onto the surface of the dental tape. The abrading material 1034 is of a gritty substance such as is known in the art for abrading a dental restorative material (i.e. a dental resin).

The threading element 1031 is formed as a needle, cone, spear, or the like of plastic, but may be formed of other like materials. As such, the threading element 1031 may be flat, round or otherwise, as long as the shape thereof is suitable for introduction into an interproximal space/area. The threading element 1031 is connected to the dental tape 1034 by glue, heat treatment, or other manufacturing process. The threading element 1031 thus easily allows the user to get the abrading dental tape portion 1034 into the interproximal space from the side thereof. Once introduced, the user can abrade the dental resin by a back and forth motion.

While the invention has been illustrated and described in detail in the drawings and foregoing description, the same is to be considered as illustrative and not restrictive in character, it being understood that preferred embodiments have been shown and described and that all changes and modifications that come within the spirit of the invention are desired to be protected.

What is claimed is:

1. A dental appliance for abrading dental resin in an interproximal space, the dental appliance comprising:
a length of a supple, synthetic monofilament dental tape having a rectangular cross section;
a dental resin abrading material provided on a surface of the length of supple, synthetic monofilament dental tape; and
a threading element connected to an end of the length of supple, synthetic monofilament dental tape, the threading element configured for reception into the interproximal space from a side thereof.

2. The dental appliance of claim 1, wherein the length of supple, synthetic monofilament dental tape comprises a PTFE.

3. The dental appliance of claim 2, wherein the threading element is formed of plastic.

4. The dental appliance of claim 1, wherein the length of supple, synthetic monofilament dental tape comprises nylon.

5. The dental appliance of claim 1, wherein the abrading material has a grit size that increases along the length of supple, synthetic monofilament dental tape.

6. The dental appliance of claim 1, wherein the threading element comprises a plastic needle.

7. A dental appliance for abrading dental resin within an interproximal tooth space, the dental appliance comprising:
a length of supple, synthetic monofilament dental tape having a rectangular cross section along its entire length;
an abrading material of a particular grit size suitable to abrade dental resin provided on one side of the length of supple, synthetic monofilament dental tape; and
a needle connected to one end of the supple, synthetic monofilament dental tape, the needle sized to allow insertion through the interproximal tooth space from a side thereof.

8. The dental appliance of claim 7, wherein the needle is formed of plastic.

9. The dental appliance of claim 7, wherein the supple, synthetic monofilament dental tape comprises PTFE.

10. The dental appliance of claim 7, wherein the grit size of the abrader comprises one of a fine texture, a medium texture and a coarse texture.

11. The dental appliance of claim 7, wherein the particular grit size of the abrading material increases along the length of the supple, synthetic monofilament dental tape.

12. A dental appliance for abrading dental resin in an interproximal tooth space, the dental appliance comprising:
a piece of PTFE dental tape having a rectangular cross section along its entire length;
an abrading material glued upon an entire length of one side of the piece of PTFE dental tape, the abrading material having a texture whose grit size and composition abrades dental resin upon continuous moving contact of the piece of PTFE dental tape against the dental resin; and
a plastic needle connected to one end of the piece of PTFE dental tape, the plastic needle sized to allow insertion through the interproximal tooth space from a side thereof.

13. The dental appliance of claim 12, wherein the abrading material is glued upon an entire length of another side of the piece of PTFE dental tape.

14. The dental appliance of claim 12, wherein the grit size of the abrading material remains constant the piece of PTFE dental floss.
